(19) United States
(12) Patent Application Publication
(10) Pub. No.: US 2010/0196541 A1
(43) Pub. Date: Aug. 5, 2010

(54) Frozen Sheeted Icing Formulation

(76) Inventors: Noel F. Galluch, Boston, NY (US); Susan Franz, Arlington Heights, IL (US); Elsie Gaite, Wauconda, IL (US)

Correspondence Address: HODGSON RUSS LLP;THE GUARANTY BUILDING, 140 PEARL STREET, SUITE 100, BUFFALO, NY, 14202-4040, US

(21) Appl. No.: 12/696,772

(22) Filed: Jan. 29, 2010

Related U.S. Application Data
(60) Provisional application No. 61/148,703, filed on Jan. 30, 2009.
(60) Provisional application No. 61/172,898, filed on Apr. 27, 2009.

(51) Int. Cl. A23G 9/24; A23G 9/34; A23G 9/44

(52) U.S. Cl. 426/68; 426/565

(57) ABSTRACT

A frozen sheeted icing comprising 2 to 10% by weight water; 10-30% by weight fat; 60-75% by weight sweetener solids; and 0.2 to 5.2% by weight of one or more gums. The composition can be prepared by mixing the ingredients to form an icing composition. The composition is then sheeted into desired shape, size and thickness. The sheeted icing is frozen and can be stored in the freezer until use. Also a method for icing a food product comprising the steps of providing a frozen sheet of icing; disposing the frozen sheet of icing on a surface of the food product; and exposing the disposed frozen sheet of icing to a temperature such that the frozen sheet of icing becomes sufficiently pliable and conforms or can be conformed to a surface of the food product. This results in forming an icing layer on the desired surfaces of the food product.

### CROSS-REFERENCE TO RELATED APPLICATIONS

This application claims priority to U.S. provisional patent application No. 61/148,703, filed Jan. 30, 2009, and U.S. provisional patent application No. 61/172,898, filed Apr. 27, 2009, the disclosures of which are incorporated herein by reference.

### FIELD OF THE INVENTION

This invention relates generally to the area of icings for foods items, and more particularly to a frozen sheeted icing formulation which is easy to use. The invention also relates to a method of icing a food item using the frozen sheeted icing formulations.

### BACKGROUND OF THE INVENTION

Icings are commonly used on baked food items to provide a desirable appearance as well as taste and flavor. In the commercial setting, because consumers desire visually appealing icing decoration, skilled decorators are needed to prepare and apply icings to desserts. However, the time and cost associated with the preparation and application of icings is often a limiting factor.

Thus, there is a need in the food industry to develop formulations that are easy to use, are more cost effective, and can be applied quickly using minimal skill, tools and equipment.

### BRIEF SUMMARY OF THE INVENTION

The invention provides a composition for frozen sheeted icing comprising 2 to 10% water; 10-30% fat; 60-75% sweetener solids, and 0.2 to 5.2% of one or more gums. The gums which can be used include, carboxymethylcellulose and derivatives thereof (CMC), gellan gum, gum Arabic, guar gum, xanthan gum, alginate, locust bean gum and the like. In one embodiment, the icing formulation comprises at least gellan gum and CMC. In another embodiment, the only gums present are gellan gum and CMC.

The composition can be prepared by mixing the ingredients to form an icing composition. The composition is then sheeted into desired shape, size and thickness. The sheeted icing is frozen and can be stored in the freezer until use.

The invention further provides a method for icing a food product comprising the steps of providing a frozen sheet of icing comprising 2 to 10% water; 10-30% fat; 60-75% sweetener solids, and one or more gums; disposing the frozen sheet of icing on a surface of the food product; and exposing the frozen sheet of icing disposed on the food product to a temperature such that the frozen sheet of icing becomes sufficiently pliable and conforms to a surface of the food product, with or without the application of external pressure, on which said frozen sheet was disposed. This results in forming an icing layer on the desired surfaces of the food product. The overall time needed for icing a cake is about 2 minutes and end of day cleanup time is about 5 minutes.

### BRIEF DESCRIPTION OF THE DRAWINGS

FIG. 1. Graphical representation of a sheeted icing.

FIG. 2. Graphical representation of placing a sheeted icing on a food product (a cake).

FIG. 3. Graphical representation of a food product (a cake) with a sheeted icing disposed on a surface of the cake.

FIG. 4. (a) Graphical representation of a sheeted icing conforming to a cake on exposure ambient temperature. (b) Graphical representation of a sheeted icing conforming to a cake on exposure to a heat source (an oven).

FIG. 5. Graphical representation of a sheeted icing conformed to a food product (a cake).

FIG. 6. Graphical representation of food product (a cake) with a design formed in the exposed surfaces of the sheeted icing that has been iced according to the present invention.

FIG. 7. Graphical representation of a shaped frozen sheeted icing on a non-stick paper.

FIG. 8. Graphical representation of a food product (a cake) on shaped frozen sheeted icing where a rigid substrate has been placed in contact with the exposed surface (surface opposite of that in contact with the sheeted icing) of the food product.

FIG. 9. Graphical representation of removal of the non-stick paper from the sheeted icing exposing a surface of the frozen sheeted icing.

FIG. 10. Graphical representation of application of pressure to conform the flaps of the sheeted icing to the surfaces of the food product (cake).

FIG. 11. Graphical representation of a shaped sheeted icing conformed to a food product (a cake).

FIG. 12. Graphical representation of food product (a cake) with a design formed in the exposed surfaces of the sheeted icing that has been iced according to the present invention.

### DETAILED DESCRIPTION OF THE INVENTION

The present invention provides a frozen sheeted icing composition, a method of making the frozen sheeted icing composition and a method for icing a food product using the frozen sheeted icing. The icing composition is prepared and frozen as a sheet. The frozen sheeted icing is then applied directly to a food product.

Typically, icing compositions are not sheetable. Various icing compositions containing no gums or a single gum, such as agar, gum Arabic, guar gum at the amounts tested were observed to be not sheetable because these compositions were generally too sticky to be rolled out as sheets. Additionally, it was also observed that even if an attempt was made to spread out the icings, the consistency of such icings was such that no design or patterns could be stamped on the spread-out icing and the icing was prone to cracking on thawing. In the present invention, it was unexpectedly observed that by using certain combinations of gums and sugar, the icing formulations could be rolled out to form sheets and the sheets could be frozen. The frozen sheeted icing retains its integrity during freezing and storage and subsequent handling. The frozen sheetable icings can be removed from the freezer and can be directly used to provide an icing layer on food products.

The icing compositions of the present invention are sheetable and exhibit desirable processing properties (such as good adherence to the food product, no cracking, and good organoleptic properties (such as mouthfeel)). Without intending to be bound by any particular theory, it is considered the compositions having the appropriate balance of sugar and gum content (i.e., sweetener solids and gums ratio) results in a sheetable composition with desirable processing properties.

All amounts are weight %, unless otherwise indicated.

The icing composition comprises 60-75%, preferably 65-70% sweetener solids; water; gums (such as carboxymethycellulose, gellan gum, gum Arabic); and fat. In various embodiments, the sweetener solids can be 60, 61, 62, 63, 64, 65, 66, 67, 68, 69, 70, 71, 72, 73, 74, or 75 wt %. The icing composition can further comprise various additives such as colorants, flavoring agents and preservatives. Decorator particulates (e.g., sprinkles, edible glitter, etc.) can optionally be added to the formulation.

In one embodiment, 60 to 100% (including all integers and ranges therebetween) of the sweetener solids component is made up of sugar, preferably powdered sugar. In another embodiment, 60, 65, 70, 75, 80, 85, 90, 95%, and all integers between 60 and 95%, of the sweetener solids component is made up of sugar, preferably powdered sugar. In another embodiment, at least 60, 65, 70, 75, 80, 85, 90, 95% of the sweetener solids component is made up of sugar, preferably powdered sugar. In the embodiments where sugar does not make up a 100% of the sweetener solids, the remaining sweetener can be corn syrup, fondant and the like, such that the sweetener solids is 60-75%.

In another embodiment, the sweeteners solids may comprise one or more intensive sweeteners, such as aspartame, acetosulfame, alitame, saccharin, cyclamates, trichloro sucrose and the like, and/or bulking agents. In the event one or more intensive sweeteners are used, bulking agents may be included in the formulation to provide additional solids. Typical bulking agents would be maltodextrin, polydextrose, polyglucose, xylitol, mannitol and sorbitol. If intensive sweeteners and/or bulking agents are used, the intensive sweetener and/or bulking agent solids should be in the range of 60-75%.

Water can be present at from 2 to 10% by weight. In various embodiments, water can present at 2, 3, 4, 5, 6, 7, 8, 9, or 10 wt %.

The present invention comprises at least one gum. In one embodiment, the gums which can be used are selected from the group consisting of gellan gum, CMC, gum Arabic, guar gum, xanthan gum, alginate and locust bean gum and combinations thereof. The gums are present at a total of from 0.2 to 5.2% by weight, including all values to 0.1% and ranges therebetween. Preferably, the gums are present at 0.4 to 4.0, 0.5 to 3.0, or 0.5 to 1.5% by weight.

In one embodiment, the icing formulation comprises at least two gums. In one embodiment, the only gums in the formulation are gellan gum and CMC. In another embodiment in which the only gums are gellan gum and CMC, gellan gum is present at 0.005 to 0.2% by weight, and CMC is present at 0.2 to 2.0% by weight. In these ranges, it was observed that the formulation was sheetable and displayed desirable properties such as lack of cracking, adherence and good mouthfeel. In another embodiment the only gums in the formulation are gellan gum and CMC, wherein CMC is present at from 0.7 to 1.8 wt %, including all percentages to the 0.01% therebetween, and gellan gum is present at from 0.008 to 0.09 wt %, including all percentages to the 0.001% therebetween.

In another embodiment the formulation comprises gellan gum, CMC and at least one additional gum. In various embodiments, the additional gum can be gum Arabic, xanthan gum, gun Acacia, alginate (e.g., ammonium or propylene glycol (PG)) and locust bean gum (LBG). In one embodiment, the additional gum is gum Arabic. In one embodiment, the composition comprises; 0.5 to 1.0%, preferably 0.6 to 0.8% CMC; 0.05 to 0.15%, preferably 0.07 to 0.1% gellan gum; 0.2% to 0.75%, preferably 0.3 to 0.6% gum Arabic.

In another embodiment, the gums comprise 0 to 0.5% gellan gum, 0 to 1.0% CMC, 0.05 to 0.3% gum Arabic, 0.05 to 0.3% guar gum, 0.05 to 1.0% xanthan gum, 0.05 to 0.3% PG alginate, 0.05 to 1.0% sodium alginate and 0 to 0.75% locust bean gum. In another embodiment, CMC alone was used at 0.05 to 3.0%.

Fat can be present at 10 to 30, including all integers therebetween, % by weight. Any vegetable oil or partially hydrogenated or hydrogenated fractions thereof can be used so long as it is solid at room temperature (68 to 75° F.). Combinations of one or more fats can also be used. Examples of fats include, but are not limited to, hard fats such as palm oil, palm kernel oil, coconut oil, babassu oil, and tucum oil, including partially hydrogenated and various fractions thereof. In one embodiment, the fat is preferably trans fat-free shortening. In another embodiment, the fat is partially hydrogenated soybean oil.

In various embodiments, different flavors can be added to the composition. For example, the flavors added include, but are not limited to, lemon, caramel, hazelnut, chocolate, strawberry, maple, peanut and non-allergenic peanut.

In one embodiment, the composition of the icing comprises: 2% to 10%, preferably 3 to 7% water; 10-30%, preferably 15 to 25%, fat (solid at temperatures from 68-75° F.); 0.5 to 1.0%, preferably 0.6 to 0.8%, carboxymethylcellulose; 0.05 to 0.15%, preferably 0.07 to 0.1%, gellan gum; optionally, 0.2% to 0.75%, preferably 0.3 to 0.6%, gum Arabic; and 60 to 75% sweetener solids.

The icing formulation of the present invention was observed to have a density of 0.8 to 1.5 g/cc. In various embodiments, the icing formulation has a density of 0.9, 1.0, 1.1, 1.2, 1.3, and 1.4 g/cc.

The present method provides a method of making frozen sheeted icing. An example of the method of making the sheeted icing of the present invention is as follows. The shortening is creamed and then the other ingredients are mixed and blended. Then, the icing composition is spread by hand or by using an apparatus, such as a sheeter, on a generally flat surface. For example, this can be done on a non-stick paper or foil, baking tray and the like to obtain a sheet of a desired thickness. The icing is cut into desired shape, optionally decorated, and then transferred to a freezer where it can be stored up to at least one year. When it is desired to be used, the sheeted icing can be removed from the freezer, placed directly on the food product on which it is to be applied. In one embodiment, the frozen sheeted icing is a sheetable icing formulation disclosed herein.

The sheeted icing can be made in any desired shape. It can be used as icing for any part of the surface, or the entire surface (such as the exposed surface), of a food product. Upon exposure to temperatures of at least 60° F. for a sufficient time, the sheeted icing becomes pliable. The shape of the frozen icing sheet defines the surface of the food product that will be covered with the icing. For example, if only the top surface of a round or a rectangular cake is to be covered, a round or a rectangular shaped frozen sheet, respectively, can be used. The round or rectangular sheets can be made pliable by exposure to temperatures at 60° F. or above resulting in the sheets conforming to the top surface of the cake. Further, the sheeted icing adheres to the food product like a fresh icing such that it does not readily fall off of the food product when it is consumed.

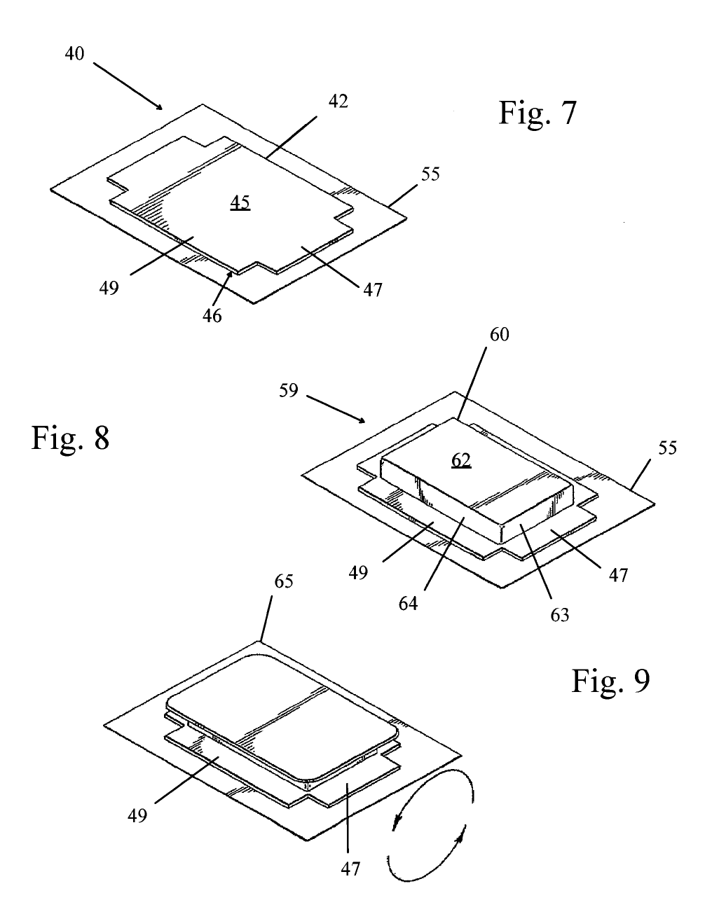

Further, if it is desirable to cover additional surfaces of a food product with icing, the sheeted icing can be made into a shape that would cover all such desired surfaces. For example, if the food product is a rectangular cake whose top surface, as well as the sides, are desired to be covered with icing, then the frozen sheeted icing can have a shape such as those illustrated in FIGS. 1 and 7. Upon exposure to ambient temperature (60 to 90° F.) for a time (e.g., 5 to 75 minutes) sufficient to render the sheet sufficiently pliable, the frozen sheeted icing will conform to the top surface of the cake and the flaps of the sheeted icing will start to drop down toward the sides of the cake. Additional pressure can then be applied to the flaps (such as with a spatula) such that they conform to the desired sides of the cake. Alternatively, upon exposure to temperatures above 90° F. for sufficient time (e.g., less than 2 minutes), the flaps will conform to the sides of the cake under their own weight with minimal or no external pressure required.

The frozen sheet can be shaped (e.g., by notching or removing part(s) of the frozen sheet which will overlap when the frozen sheet conforms to the shape of the food product) such that it conforms to the shape of the food product. For example, a shaped frozen icing sheet is illustrated in FIG. 7. Thus, in one embodiment, the frozen icing sheet is shaped such that it conforms to the food product with no, or minimal, overlap.

If desired, the sheeted icing can be decorated prior to freezing. In one embodiment, the surface of the sheet (or any part of the frozen sheet) can be imprinted with a pattern, design or writing. For example, a pattern of depressions, or design or writing made up of depressions can be made in one or more surfaces (e.g., 37, 38, 39, 47 and 49) of the sheet of icing (see, e.g., FIGS. 6 and 12). In one embodiment, any desired design or pattern can be formed on the top or bottom, or both, of the icing sheet, or both. In another embodiment, a preexisting design, pattern or writing (e.g., an edible image) can be placed in contact with the exposed surface of the sheeted icing so as to stick to the sheeted icing. In yet another embodiment, the surface of the sheeted icing can be decorated by airbrushing.

The icing formulation can be formed into sheets (e.g., rectangular or round) of any desired size and/or shape. It is preferable that the sheets do not exhibit cracking on thawing. For example, frozen sheeted icing can have the dimensions necessary to cover a full-sheet, half-sheet, or one-quarter sheet cake. In another example, a sheeted icing can be 26 inches in length by 18 inches in width, or 13 inches in length by 9 inches in width, or 11 inches in length by 14 inches in with, and 1 inch in thickness, can be prepared according to the present invention.

The thickness of the frozen sheeted icing can be produced in any desired thickness. In one embodiment, the thickness of the frozen sheeted icing is from 0.05 to 1 inch, including all values to the 0.01 inch and ranges therebetween.

In another embodiment, the icing composition can be formed into any desired shape (including, for example, a flower, a swan, a sphere, a pyramid, a crescent, etc.) which can be used as an edible decoration for a food item (e.g., a cake). For example, such icing shapes (e.g. swan-shaped icing) may be substantially flat or three-dimensional.

The frozen and precut icing sheets can be shipped in biodegradable corrugates. The frozen sheeted icing can be directly transferred from the freezer to a food product.

In one aspect, the present invention provides a method for icing a food product. For example, the present invention provides a fast, economical method to ice a cake. The icings are visually appealing, have good organoleptic properties and require no skilled labor, special tools or clean-up. The method decreases costs by reducing the need for skilled labor, simplified manufacturing process eliminates the need for some equipment (e.g., no Unifiller-type equipment is needed), and reduces waste. Icing a cake is easily carried out by placing the frozen icing sheet on a food product (e.g., a cake or some other dessert). Upon application of heat for a brief period of time (such as about a minute), a nicely iced food product is obtained.

Generally, the method includes placing a frozen sheet of icing on food product, such as a cake, and exposing the frozen sheet/cake combination to conditions such that the sheeted icing forms a layer on and about the food product (e.g., conforming to the shape of the food product), as desired. The food product with the frozen sheet on top can be allowed to thaw at room temperature or exposed briefly to heat (in an oven or microwave, or using a hairdryer or a heat lamp and the like), which results in the sheeted icing losing its rigidity and conforming to the surfaces of the food product on which it is placed. It is preferable that the sheeted icing does not melt so as to render it unusable. Also, pressure (such as by hand) may be applied to the sheeted icing to aid in conforming the sheet to the food product. The surface of the food product covered by the icing will be determined by the shape of the icing sheet. For example, the shape of the icing sheet can be designed such that it covers all or a portion of the exposed surface of the food product (e.g., top and sides of a cake). By careful measurement and design the overlap of the sheeted icing can be minimized or eliminated to provide a uninterrupted and uniform icing layer.

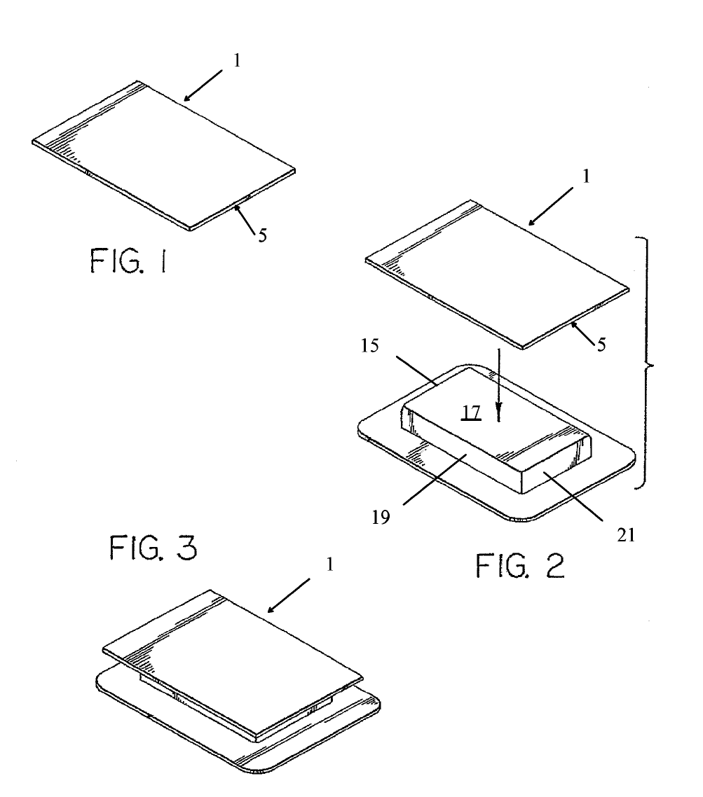

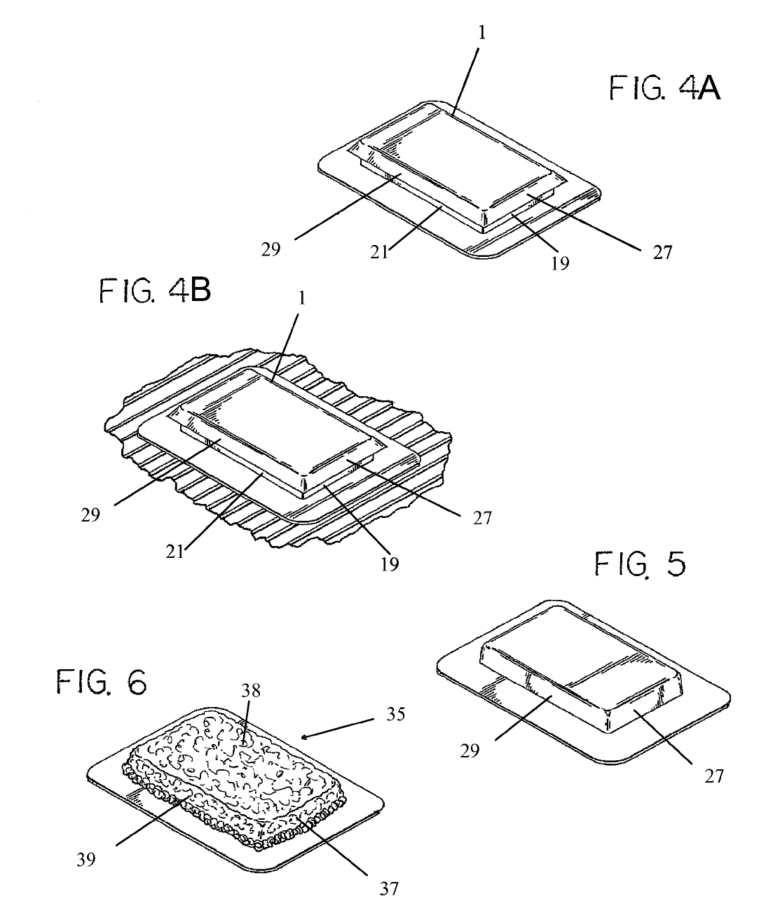

The method, in one embodiment, is illustrated in FIGS. 1-3, 4A and 5. The method for icing a food product 15 comprises the steps of: (a) placing a frozen sheet 1 of icing having the appropriate size and shape, the composition of which is described herein, such that a surface 5 of the frozen sheet 1 is at least partially in contact with a top surface 17 of the food product 15; and (b) allowing the frozen sheet 1 of icing to conform to the food product 15, thereby forming an icing layer on the food product. For example, flaps 27, 29 of the frozen sheet 1 may conform to contact exposed surfaces 19, 21 of the food product 15.

In one embodiment, the frozen sheet 1 of icing is allowed to conform to the food product 15 by thawing at a temperature of 60 to 90° F. (e.g., thawing at ambient temperature without subjecting the sheeted icing to an additional source of heat) for five to seventy five minutes, including all integers therebetween. Force can be applied, for example, to cause the pliable frozen sheet 1 to conform to the food product 15 by, for example, pressing the surfaces (e.g., flaps 27 and 29) of the pliable frozen sheet 1 not in contact with the food product 15 against the food product 15 (e.g., exposed surfaces 19 and 21) (see, e.g., FIG. 11).

In one embodiment, when the frozen sheeted reaches a temperature of 60° F., and preferably 62° F., it becomes sufficiently pliable for conforming to a food product. For example, to bring a frozen sheeted icing to a temperature of 60° F., exposure of the sheeted icing to an ambient temperature of 65° F. for 47 minutes, 74.5° F. for 25 minutes, or 85° F. for 15 minutes was required. In another example, to bring a frozen sheeted icing to a temperature of 62° F., exposure of the sheeted icing to an ambient temperature of 65° F. for 55 minutes, 74.5° F. for 28 minutes, or 85° F. for 16.5 minutes was required.

In another embodiment, illustrated in FIGS. 1-2 and 4B and 5, the frozen sheet 1 of icing conforms to the other exposed surfaces 19, 21 of the food product by exposing the frozen sheet 1 of icing to heat at a temperature of from 90 to 350° F. for a period of time. For example, the period of time can be two seconds to two minutes, including all values to the second therebetween. In another example, the period of time is sufficient to allow the frozen sheet 1 to conform to the food product 15.

The exposure to heat step can be carried out using a convection oven, microwave oven, heat lamp or hair dryer, and the like. For example, in one embodiment, the frozen sheet is placed on a cake, placed in the oven (set at about 300-325° F.) for 1 minute and then removed from the oven. The application of heat slightly softens the icing sheet (making it pliable) and allows it to conform to the contours of the cake.

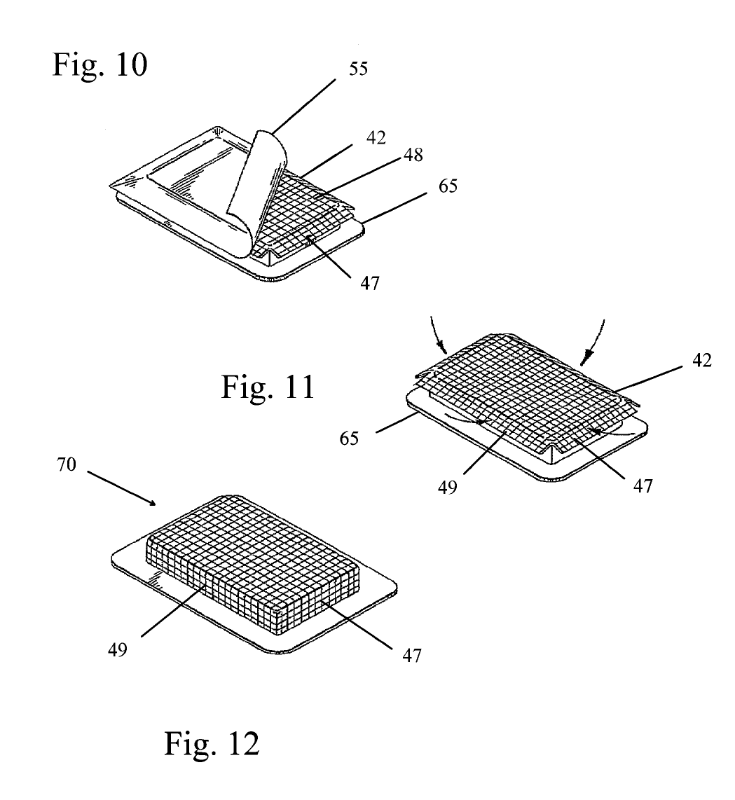

A method according to another embodiment is illustrated in FIGS. 7-12. In this embodiment, a shaped (e.g., notched) frozen sheet 42, is used. The shaped frozen sheet 42 has a removable covering 55 in contact with a surface 46 of the frozen sheet 42, the combination 40 is shown in, for example, FIG. 7. A food product 60 is placed on (e.g., in contact with) the exposed surface 45 of the frozen sheet 42 such that flaps 47, 49 are not covered by the food product 60. The flaps 47, 49 can, for example, be configured to cover the other surfaces 63, 64 (sides) of the food product 60 which are not otherwise covered by the frozen sheet 42 (see FIG. 8). A rigid substrate 65 (such as a plastic or metal tray, or cardboard placard) is placed on an exposed surface 62 of the food product (see FIG. 8). This frozen sheet 42/food product 60 combination 59 can be inverted (see, e.g., FIG. 9). The removable covering 55 is then removed to expose a surface 48 of the frozen sheet 42 (see FIG. 10). The flaps 47 49 are conformed to the food product (e.g., by application of pressure to the flaps 47, 49) (see FIG. 11). The result is an iced food product 70 which is shown in, for example, FIG. 12.

The icing on a food product formed by using the frozen sheeted icing can provide an uninterrupted contiguous layer.

The food product can be any baked product (such as cakes, doughnuts, muffins, biscuits, cookies and the like) to which it is desirable to have an icing layer applied. In another embodiment, the food product is a non-baked food product, such as an ice cream cake.

For applying the icing to the cake, the icing sheets may be placed onto racks and then placed into a rack oven consolidating the oven process time. The overall time needed for icing a cake is about 2 minutes and end of day cleanup time is about 5 minutes.

The following examples are presented to illustrate the present invention. They are not intended to limiting in any manner.

### Example 1

The following formulation is an illustration of the formula that was used to prepare the icing. The ingredients are listed in the order they were added.

TABLE 1

| Ingredient | % | pounds |
|---|---|---|
| Trans fat-free shortening | 21.85% | 1000 |
| Water | 3.57% | 163.2 |
| Citric acid | 0.06% | 2.6 |
| Corn syrup | 1.31% | 60 |
| Titanium dioxide | 0.74% | 34 |
| 12X sugar | 69.93% | 3200 |
| Salt flour | 0.10% | 4.4 |
| CMC | 0.83% | 38 |
| Gum arabic | 0.48% | 21.8 |
| gellan gum | 0.09% | 4.2 |
| Potassium sorbate | 0.09% | 4 |
| Sodium benzoate | 0.09% | 4 |
| Flavor | 0.87% | 40 |
| Total | 100.00% | 4576.2 |

### Example 2

This example describes a chocolate rolled icing formulation. Again, the ingredients are listed in the order they were added.

TABLE 2

| Ingredient | % | pounds |
|---|---|---|
| Trans fat-free shortening | 15.00% | 800 |
| Chocolate donut icing | 17.10% | 912 |
| Water | 5.66% | 301.6 |
| Citric acid | 0.15% | 8 |
| 12X sugar | 56.26% | 3000 |
| Salt flour | 0.32% | 17 |
| CMC | 0.73% | 39 |
| Gum arabic | 0.41% | 21.8 |
| gellan gum | 0.08% | 4.2 |
| Cocoa | 3.75% | 200 |
| Potassium sorbate (optional) | 0.09% | 5 |
| Sodium benzoate (optional) | 0.08% | 4 |
| Flavor | 0.38% | 20 |
| Total | 100.00% | 5332.6 |

### Example 3

This example provides another vanilla formulation for the present invention. In addition to the formulations presented above, this formulation contains monodiglyceride acetic acid ester and cream of tartar. It is believed that the addition these two ingredients made the icing fluffier in texture, increased the volume and gave it an upfront flavor release.

TABLE 3

| Ingredient | % | pounds |
|---|---|---|
| Shortening palm oil | 21.43% | 500 |
| Monodiglyceride acetic acid ester | 1.28 | 30 |
| Water | 3.5% | 81.6 |
| Citric acid | 0.06% | 1.3 |
| Corn syrup | 1.28% | 30 |
| Titanium Dioxide | 0.73% | 17 |
| 12X sugar | 68.57% | 1600 |
| Flavor | 1.39 | 32.4 |
| salt flour | 0.09% | 2.2 |
| CMC | 0.81% | 19 |
| Gum Arabic | 0.47% | 10.9 |
| Gellan gum | 0.09% | 2.1 |
| cream of tartar | 0.12 | 2.8 |
| Potassium sorbate (optional) | 0.09% | 2 |
| Sodium benzoate (optional) | 0.09% | 2 |
| Total | 100% | |

Provided below is the chocolate formulation.

TABLE 4

| Ingredient | % | pounds |
|---|---|---|
| Shortening palm oil | 14.68% | 400 |
| Monodiglyceride acetic acid ester | 0.73 | 20 |
| Water | 5.54% | 150.8 |
| Citric Acid | 0.15% | 4 |
| Corn Syrup | 3.67% | 100 |
| Potassium sorbate | 0.09% | 2.5 |
| Sodium benzoate | 0.07% | 2 |
| Chocolate donut icing | 16.74 | 456 |
| Flavor | 1.61% | 44 |
| 12X sugar | 51.39% | 1400 |
| Ceam of tartar | 0.15 | 4 |
| Salt flour | 0.31% | 8.5 |
| CMC | 0.71% | 19.5 |
| gellan gum | 0.08% | 2.1 |
| Gum arabic | 0.40% | 10.9 |
| Cocoa, natural | 1.84% | 50 |
| Cocoa powder | 1.84% | 50 |
| Total | 100% | |

### Example 4

The following are icing formulations which were not sheetable.

TABLE 5

| | % Solid (Based on Sweetener | |
|---|---|---|
| | Solids - Sugar, Corn Syrup, | |
| Product Description | HFCS and Fondant) | Gums |
| Flat icing | 67.46% | No Gums |
| Flat icing | 61.35% | No Gums |
| Flat icing | 67.42% | No Gums |
| Chocolate Buttercreme Icing | 52.06% | No Gums |
| Swiss Chocolate Buttercreme Icing | 64% | No Gums |
| Cinnamon Roll Icing | 51% | No Gums |
| Buttrcreme Icing (Contains 14.84% Fondant) | 60% | Guar Gum = 0.089% |
| Cream Cheese Icing | 65.41% | Guar Gum = 0.155% |
| White Buttercreme Icing | 60.64% | Guar Gum = 0.177% |
| Flat (Contain 50% Fondant) | 84.71% | Agar = 0.09% |
| | | Locust Bean Gum = 0.013% |
| Buttercreme Icing | 62.11% | Guar Gum = 0.184% |
| Colored Buttrcreme Icings | 63.00% | Guar Gum = 0.111% |
| Fluffy White Buttrcreme Icing | 61.68% | Guar gum = 0.183% |
| Fluffy Buttrcreme Icing | 56.84% | CMC 7H3SXF = 0.077% |
| Sugar Free Chocolate Buttercreme Icing | 35.00% | Guar Gum = 0.586% |
| Sugar Free White Buttercreme Icing | 30.00% | Guar Gum = 0.343% |
| Chocolate Frosting | 61.06% | Agar = 0.039% |
| Buttercreme Icing | 66.72% | Guar Gum = 0.213% |
| Flat Icing (Containing 35% Fondant) | 81.41% | Agar = 0.112% |
| Flat Icing (Contain 89% Fondant) | 83.23% | Agar = 0.045% |
| | | Gum Arabic = 0.214% |

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1. A method for icing a food product comprising:
(a) providing a frozen sheet of icing comprising 2 to 10% by weight water; 10-30% by weight fat; 60-75% by weight sweetener solids, and one or more gums;
(b) disposing the frozen sheet of icing on a surface of the food product; and
(c) exposing the frozen sheet of icing from b) to a temperature such that the frozen sheet of icing becomes pliable and conforms to at least the surface of the food product on which said frozen sheet was disposed, thereby forming an icing on the food product.

2. The method of claim 1, wherein the amount of the one or more gums is between 0.2 to 5.2 by weight.

3. The method of claim 2, wherein the one or more gums is selected from the group consisting of gum Arabic, carboxymethylcellulose (CMC), gellan gum, guar gum, xanthan gum, alginate, locust bean gum and combinations thereof.

4. The method of claim 2, wherein the only gums in the frozen sheet of icing are gellan gum and carboxymethylcellulose.

5. The method of claim 2, wherein the one or more gums comprise gellan gum and CMC and a gum selected from the group consisting of gum Arabic, guar gum, xanthan gum, alginate and locust bean gum and combinations thereof.

6. The method of claim 1, wherein at least 60% by weight of the sweetener solids is powdered sugar.

7. The method of claim 1, wherein the frozen sheet conforms to the surface of the food product by exposing to a temperature of from 60 to 350° F.

8. The method of claim 6, wherein the frozen sheet is exposed to a temperature of from 60 to 90° F. for a period of 5 to 75 minutes.

9. The method of claim 6, wherein the frozen sheet is exposed to a temperature of from 90 to 350° F. for a period of less than 2 minutes.

10. The method of claim 9, wherein the exposure to a temperature of from 90 to 350° F. is carried out by use of a convection oven, microwave oven, heat lamp or hair dryer.

11. The method of claim 1, wherein step c) further comprises applying pressure to the pliable frozen sheet such that the pliable frozen sheet conforms to said surface and at least one additional surface of the food product.

12. The method of claim 1, wherein the food product is a baked product.

13. The method of claim 1, wherein the sheeted icing has a thickness of 0.05 to 1 inch.

14. The method of claim 1, wherein the frozen sheet of icing is prepared by mixing 2 to 10% by weight water; 10-30% by weight fat; 60-75% by weight sweetener solids, and one or more gums; sheeting the mixture and freezing the divided sheets.

15. The method of claim 14, wherein the sheeted icing is decorated prior to freezing.

16. A frozen sheeted icing comprising 2 to 10% by weight water; 10-30% by weight fat; 60-75% by weight sweetener solids, and 0.2 to 5.2% by weight of one or more gums, wherein the fat is solid at temperatures from 68 to 75° F.

17. The frozen sheeted icing of claim 16, wherein the one of more gums is selected from the group consisting of gum Arabic, carboxymethylcellulose (CMC), gellan gum, guar gum, xanthan gum, alginate, locust bean gum and combinations thereof.

18. The frozen sheeted icing of claim 16 where the only gums in the composition are gellan gum and CMC.

19. The frozen sheeted icing of claim 16, wherein at least 60% by weight of the sweetener solids is powdered sugar.

20. The frozen sheeted icing of claim 16, having a thickness of from 0.05 to 1 inch.
